(19) United States
(12) Patent Application Publication
(10) Pub. No.: US 2012/0288784 A1
(43) Pub. Date: Nov. 15, 2012

(54) FUEL CELL PLATE WITH RECYCLED MATERIAL

(76) Inventors: Stephen P. Victor, Guilford, CT (US); Braden R. Kattman, Glastonbury, CT (US)

(21) Appl. No.: 13/521,251

(22) PCT Filed: Feb. 1, 2010
(86) PCT No.: PCT/US10/22691

§ 371 Date: Jul. 10, 2012

(51) Int. Cl. H01M 8/02; H01M 8/00

(52) U.S. Cl. 429/512; 264/319; 429/535

(57) ABSTRACT

A method of manufacturing a fuel cell plate is disclosed that includes machining a part to produce tailings. At least some of the tailings are mixed with a material to produce a mixture. The mixture is formed into a fuel cell plate. In one example, the tailings are recycled flake graphite laminated with binder, and the material is virgin flake graphite mixed with binder. The fuel cell plate has a structure with surfaces extending in the in-plane direction. At least some of the natural flake graphite is arranged out of the in-plane direction.

### BACKGROUND

This disclosure relates to a fuel cell plate having recycled material and a method for manufacturing the same.

Some types of fuel cells, such as phosphoric acid fuel cells, utilize solid plates in which anode, cathode and/or coolant flow fields are provided on at least one of opposing sides. One type of solid plate is manufactured from virgin natural flake graphite that is mixed with a fluoropolymer binder. The properties of a given natural flake graphite is dependent upon the graphite properties and form. Typically, most virgin natural flake graphites are not able to meet all of the required specifications for the solid plate. For example, a given virgin graphite material may pass the corrosion requirements, but typically fail requirements for thermal conductivity, in particular, through-plane thermal conductivity. Natural flake graphite is very planerized in its shape such that when molded, such that virtually all of the flakes form a brick wall-like configuration oriented in an in-plane direction. This brick wall-like configuration provides good in-plane thermal conductivity but poor through-plane thermal conductivity.

Manmade graphite may be used in manufacturing the plate. The manmade graphite is smaller and more isotropic when molded than natural flake graphite. As a result, more binder is provided between the graphite, which insulates the graphite thereby reducing the overall thermal conductivity of the plate by an undesirable amount.

### SUMMARY

A method of manufacturing a fuel cell plate is disclosed that includes machining a part to produce tailings. At least some of the tailings are mixed with a material to produce a mixture. The mixture is formed into a fuel cell plate. In one example, the tailings are recycled natural flake graphite laminated with binder, and the material is virgin flake graphite mixed with additional binder.

The fuel cell plate has a structure with opposing surfaces extending in the in-plane direction. As a result some of the natural flake graphite is arranged out of the in-plane direction.

### BRIEF DESCRIPTION OF THE DRAWINGS

The disclosure can be further understood by reference to the following detailed description when considered in connection with the accompanying drawings wherein:

FIG. 1 is a magnified cross-sectional view of a fuel cell plate with virgin natural flake graphite and recycled tailings that include natural flake graphite laminated together with a binder.

FIG. 2 is a flow chart depicting an example fuel cell plate manufacturing method.

FIG. 3 is a schematic view of a portion of the fuel cell plate manufactured according to the method illustrated in FIG. 2.

### DETAILED DESCRIPTION

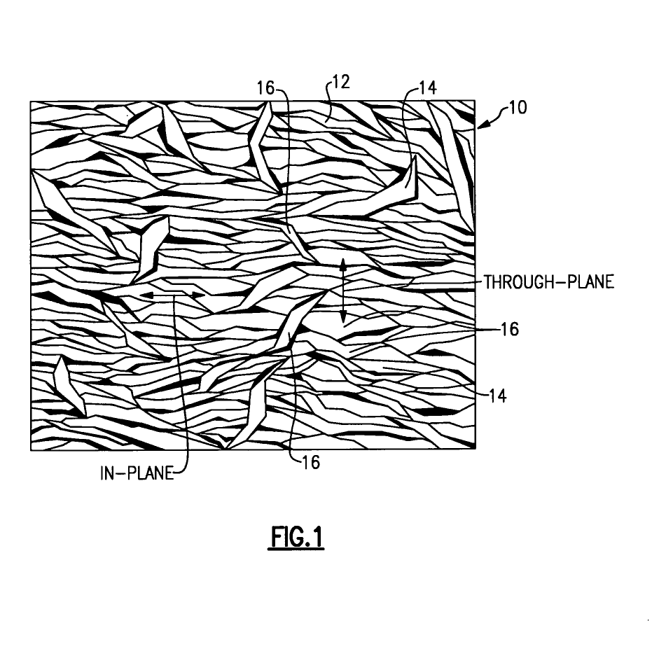

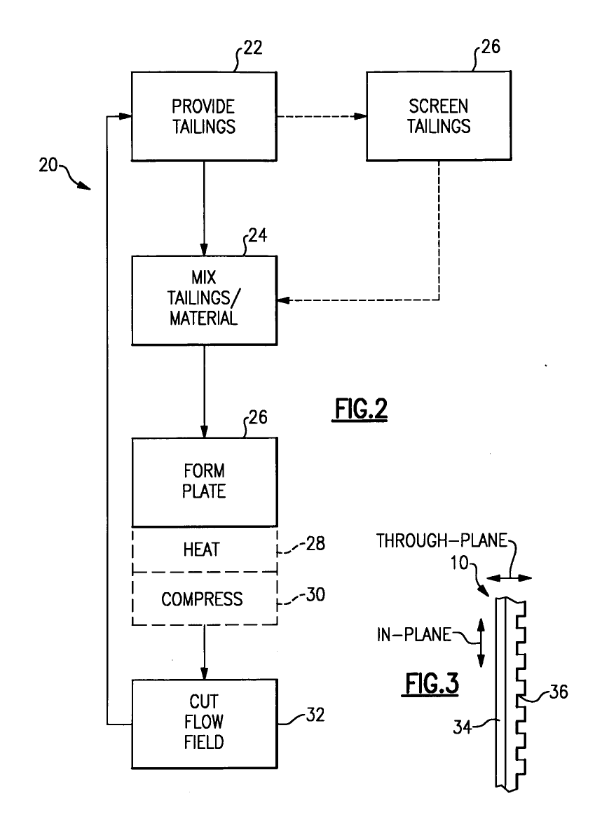

A fuel cell plate 10 is illustrated in FIG. 1 as a magnified cross-section. The plate 10 is constructed from a mixture of virgin natural flake graphite 12 and recycled tailings 16, which includes natural flake graphite laminated together with a binder 14. Adding recycled tailings 16 to the fuel cell plate 10 improves the through-plane thermal conductivity, which enables the use of virgin natural flake graphite that would otherwise not meet through-plane thermal conductivity requirements. The virgin natural flake graphite 12 is very planerized, for example, an aspect ratio of approximately 1.8. One example binder 14 is a fluoropolymer based binder, which may be a fluoroelastomer, such as fluoronated ethylene propylene (FEP).

In one example, the tailings 16 or rubble are the machining byproducts or chips produced while machining a part, such as other fuel cell plates. The tailings are produced, for example, when machining anode, cathode and/or coolant flow fields in the plate. In one example, the chips are approximately 0.008 in (0.203 mm) average size. In one example, the size of the tailings 16 is slightly more coarse than the virgin natural flake graphite.

In one example, it is desirable to provide tailings 16 of a size with the largest dimension less than 1.00 mm (0.04 in), for example, by screening the tailings 16 with an 18 mesh screen. The tailings 16 consist of natural flake graphite that is laminated with a binder, which may be the same binder that is used to produce the fuel cell plate 10. It should be understood that the virgin natural flake graphite 12 may be the same or different than the natural flake fiber contained in the tailings 16. Similarly, the binder used in the tailings 16 may be different than the binder mixed with the virgin natural flake graphite 12 and the tailings 16. Thus, the rubble, virgin natural flake graphite and binder can be mixed and matched to provide a mixture that result in desired fuel cell plate properties, including through-plane thermal conductivity.

One example plate machining process that produces tailings of a desired size utilizes a gang mill-type cutter on a CNC or horizontal mill. The flow fields, which consist of multiple channels, are cut across the entire plate in one to two passes during a climb milling operation in which the cutter cuts rotates in a counter-clockwise direction while the plate is fed in the same direction of rotation. In one example, the tailings are produced during a climb milling machining process in which the cutter rotates at approximately 460 rpm and the plate is fed into the cutter at a feed rate of approximately 15 inches/minute (38 cm/minute). The cutter used in the climb milling process not only includes the cutters that form the flow fields but also include cutters that machine the face of the plate in which the flow fields are formed. In one example, the anode flow field channels are approximately 0.63 mm (0.02 inches) wide and 1.0 mm (0.04 inches) deep, and the cathode flow field channels are approximately 0.63 mm (0.02 inches) wide and 0.72 mm (0.03 inches) deep. It should be understood that other processes may produce tailings of a desirable size.

The tailings 16 produced by the above machining process, for example (block 22), are approximately 1000 gm size. One size distribution of tailings is screened using a 14 mesh yielding tailing of approximately 1.41 mm (0.06 in). The tailings may be screened (block 26) to limit tailings to a desired size, for example, 1.41 mm (0.06 in) and smaller. The tailings 16 and virgin natural flake graphite 12 are mixed along with additional binder 14 to produce a mixture (block 24). The mixture is deposited into a form and leveled (block 26). The mixture is heated (block 28) to approximately 650° F. (343° C.) and compressed (block 30) to 400-800 psi (2758-5516 kPa). The fuel cell plate 10 produced by the method 20 has a density of greater than 2.00 g/cc (0.0723 lb/in³), and in one example approximately 2.05 g/cc (0.0741 lb/in³). The forming process orients the natural flake graphite generally in the in-plane direction, however, some are arranged out of the in-plane direction. The through-plane thermal conductivity is at least approximately 7 BTU/ft-hr-° F. (12 W/m-K). In one example, approximately 11-14% binder is used in the mixture, inclusive of the binder contained within the tailings, and in one example, 13.5%. Up to 100% recycled tailings can be used to produce the plate 10. In one example, 45-85% tailings 16 are used to manufacture a fuel cell plate with desired properties.

Flow fields 34, 36 are machined (block 32) on opposing sides of the fuel cell plate, as shown in FIG. 3, for example. A climb milling operation may be used to cut the flow fields 34, 36 for example. The tailings from the machined fuel cell plate can be recycled and used to form the next fuel cell plate.

Although an example embodiment has been disclosed, a worker of ordinary skill in this art would recognize that certain modifications would come within the scope of the claims. For that reason, the following claims should be studied to determine their true scope and content.

What is claimed is:

1. A method of manufacturing a fuel cell plate comprising:
machining a part which produces tailings;
mixing at least some of the tailings with a material to produce a mixture; and
forming the mixture into a fuel cell plate.

2. The method according to claim 1, wherein the tailings include a first natural flake graphite, and the material includes a second natural flake graphite.

3. The method according to claim 2, wherein the tailings of the machining step includes a first binder laminating the first natural flake graphite, and the material includes a second binder.

4. The method according to claim 3, wherein the first and second natural flake graphite are of the same properties, and the first and second binder are the same.

5. The method according to claim 2, wherein the fuel cell plate includes through-plane and in-plane directions, and the forming step includes orienting the natural flake graphite generally in the in-plane direction, wherein the fuel cell plate provides a through-plane thermal conductivity of at least approximately 7 BTU/ft-hr-° F.

6. The method according to claim 1, wherein a majority of the tailings have a size of 1.41 mm or less.

7. The method according to claim 6, comprising the step of screening the tailings to provide the size.

8. The method according to claim 6, wherein the material includes natural flake graphite having an aspect ratio of approximately 1:8.

9. The method according to claim 1, wherein the part includes a formed fuel cell plate, and the machining step includes cutting a flow field in the formed fuel cell plate to produce the tailings.

10. The method according to claim 1, wherein the tailings provide approximately 45-85% of the mixture by volume.

11. The method according to claim 1, wherein the mixture includes approximately 11-14% binder by volume.

12. The method according to claim 1, wherein the binder is a fluoropolymer.

13. The method according to claim 1, wherein the forming step includes compressing the mixture greater than 400 psi to less than approximately 800 psi.

14. The method according to claim 13, wherein the forming step includes heating the mixture to approximately 650° F.

15. The method according to claim 13, wherein the fuel cell plate includes a density of at least approximately 2.00 g/cc.

16. A fuel cell plate comprising:
a structure having opposing surfaces with at least one of the opposing surfaces extending in an in-plane direction and having a flow field including multiple channels, the structure including natural flake graphite having at least some arranged out of the in-plane direction.

17. The fuel cell plate according to claim 16, wherein the structure provides a through-plane thermal conductivity of at least approximately 7 BTU/ft-hr-° F.

18. The fuel cell plate according to claim 16, wherein the structure includes a density of at least approximately 2.00 g/cc.

19. The fuel cell plate according to claim 16, wherein the structure includes approximately 11-14% of a binder by volume.
